(19) United States
(12) Patent Application Publication
(10) Pub. No.: US 2026/0199935 A1
(43) Pub. Date: Jul. 16, 2026

(54) MOVABLE COATING SYSTEM

(71) Applicant: Saudi Arabian Oil Company, Dhahran (SA)

(72) Inventors: Tariq A. Khathami, Dammam (SA); Abdullah M. Salma, Dammam (SA); Abdulrahman E. Sayed, Dhahran (SA); Essa I. Alnaimi, Dhahran (SA); Sadiq J. Alaskar, Juatha (SA); Maher H. Alerwi, Dhahran (SA)

(73) Assignee: Saudi Arabian Oil Company, Dhahran (SA)

(21) Appl. No.: 19/016,332

(22) Filed: Jan. 10, 2025

(51) Int. Cl. B05D 7/22; B05B 13/06

(52) U.S. Cl. CPC B05D 7/225; B05B 13/0618

(57) ABSTRACT

A coating device for coating an internal wall of a hollow vessel is disclosed. The coating device comprises a body defining an internal chamber, a flowable coating material stored in the internal chamber, a cavity defined in the body, a coating delivery member supported in the cavity, the coating delivery member movable between a first position and a second position, and a channel defined in the body. The channel extends between the cavity and the internal chamber, wherein the coating material flows out of the internal chamber through the channel, wherein the coating delivery member prevents the coating material from flowing out of the channel when the coating delivery member is in the first position, and wherein the coating delivery member facilitates the coating material to flow out of the channel when the coating delivery member is in the second position.

### FIELD OF THE INVENTION

The present disclosure relates to methods and systems for applying a flowable material, such as a coating material, to a hollow vessel such as a pipeline and/or lines of chemical processing equipment.

### BACKGROUND OF THE INVENTION

In the petrochemical industry, it is critical to maintain the integrity and efficiency of the assets. Hollow vessels, such as pipelines, transport various fluids including oil, gas and water. Such hollow vessels are often subjected to harsh environmental conditions and operational stresses leading to corrosion and other forms of degradation which represent a significant risk to both the environment and the operational efficacy of the pipeline system.

In an effort to combat the harsh stresses placed upon the hollow vessels, the inner surface of the system is coated with a protective coating layer which serves to mitigate the damages and protect the integrity of the system. However, the coating layer degrades and erodes with time. Such degradation of the coating layer can lead to the formation of weak spots that become points of failure. As such, the coating layer needs to be reinforced and/or reapplied over time. Currently, the methods for reapplying this protective coating layer require the system to be taken offline, or otherwise shutdown, in order to reapply the coating layer, or even require the pipeline to be entirely replaced, which is costly and time-consuming.

### SUMMARY OF THE INVENTION

According to at least one aspect of the present disclosure, a coating device for coating an internal wall of a hollow vessel is disclosed. The coating device comprises a body defining an internal chamber, a flowable coating material stored in the internal chamber, a cavity defined in the body, a coating delivery member supported in the cavity, the coating delivery member movable between a first position and a second position, and a channel defined in the body. The channel extends between the cavity and the internal chamber, wherein the coating material flows out of the internal chamber through the channel, wherein the coating delivery member prevents the coating material from flowing out of the channel when the coating delivery member is in the first position, and wherein the coating delivery member facilitates the coating material to flow out of the channel when the coating delivery member is in the second position.

According to at least one aspect of the present disclosure, a coating system is disclosed. The coating system comprises a coating device, a hollow vessel comprising an internal wall and an external wall, and a magnet selectively positioned on the external wall of the hollow vessel, wherein the coating device is selectively positioned against the internal wall of the hollow vessel by the magnet. The coating device comprises a body defining an internal chamber, a flowable coating material stored in the internal chamber, a cavity defined in the body, a coating delivery member supported in the cavity, the coating delivery member movable between a first position and a second position, and a channel defined in the body, wherein the channel extends between the cavity and the internal chamber, wherein the coating material flows out of the internal chamber through the channel, wherein the coating delivery member prevents the coating material from flowing out of the channel when the coating delivery member is in the first position, and wherein the coating delivery member facilitates the coating material to flow out of the channel when the coating delivery member is in the second position.

According to at least one aspect of the present disclosure, a method for delivering a coating material to an interior wall of a hollow vessel is disclosed. The method comprises introducing a coating device into the hollow vessel, the coating device comprising a body defining an internal chamber, a flowable coating material stored in the internal chamber, a cavity defined in the body, a coating delivery member supported in the cavity, the coating delivery member movable between a first position and a second position, and a channel defined in the body, wherein the channel extends between the cavity and the internal chamber. The method further comprises positioning a magnet on an external wall of the hollow vessel at a first location, activating the magnet to attract the coating device to the first location, displacing the coating delivery member into the second position by bringing the coating delivery member into contact with the internal wall of the hollow vessel, and deactivating the magnet to release the coating device from the first location, wherein the coating delivery member is biased into the first position when the coating delivery member is no longer in contact with the internal wall of the hollow vessel.

### BRIEF DESCRIPTION OF THE DRAWINGS

The following detailed description of specific embodiments of the present disclosure can be best understood when read in conjunction with the following drawing, where like structure is indicated with like reference numerals and in which:

FIG. 1 is a perspective view of a coating device according to at least one aspect of the present disclosure;

FIG. 2 is a cross-sectional view of the coating device of FIG. 1 according to at least one aspect of the present disclosure;

FIG. 3 is a partial cross-sectional view of the coating device of FIG. 1 positioned away from a wall of a hollow vessel according to at least one aspect of the present disclosure;

FIG. 4 is a partial cross-sectional view of the coating device of FIG. 1 positioned adjacent to the wall of the hollow vessel of FIG. 3 according to at least one aspect of the present disclosure;

FIG. 5 is a partial cross-sectional view of a coating device according to at least one aspect of the present disclosure;

FIG. 6 is a partial cross-sectional view of the coating device of FIG. 5 positioned away from a wall of a hollow vessel according to at least one aspect of the present disclosure;

FIG. 7 is a partial cross-sectional view of the coating device of FIG. 5 positioned adjacent to the wall of the hollow vessel of FIG. 6 according to at least one aspect of the present disclosure;

FIG. 8 is a perspective view of a coating device according to at least one aspect of the present disclosure;

FIG. 9 is a side view of the coating device of FIG. 8 according to at least one aspect of the present disclosure; and

FIG. 10 is an end view of a hollow vessel having the coating device of FIG. 8 positioned adjacent a wall of the hollow vessel according to at least one aspect of the present disclosure;

### DETAILED DESCRIPTION OF THE INVENTION

Shortcomings in current coating technology have led to a need for a device that can be used to apply and/or repair a coating layer of a hollow vessel while the system remains active. The coating devices discussed herein enhance pipeline maintenance by allowing continuous operation of the pipeline during the coating process, which eliminates downtime and its associated costs. Additionally, the disclosed coating devices improve safety by minimizing the need for manual intervention in hazardous environments while also addressing the challenge of corrosion prevention more effectively as real-time application of protective coatings significantly reduces the risk of corrosion by ensuring timely and/or thorough coverage.

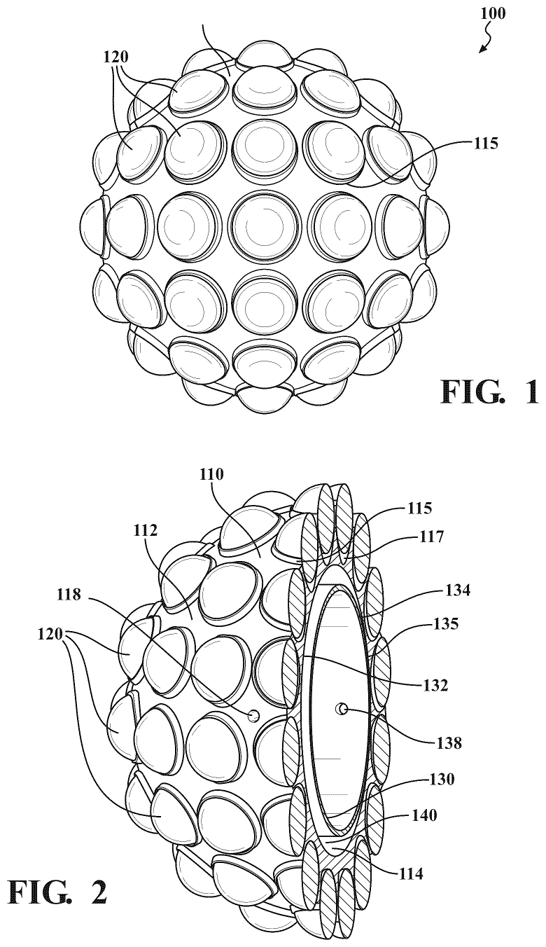

FIGS. 1 and 2 depict a coating device 100 movable through a hollow vessel to selectively apply a flowable material, such as a coating material, to a wall of the hollow vessel. The coating device 100 includes a body 110 that is generally spherical to allow the coating device 100 to roll, or otherwise move, along the wall of the hollow vessel. The body 110 of the coating device 100 includes an exterior surface 112 and an interior surface 114. At least a portion of the body 110 of the coating device 100 is made of a ferromagnetic material to allow for the coating device 100 to be selectively moved through the hollow vessel by an external magnetic field, for example. Additionally or alternatively, one or more ferromagnetic members can be coupled to the body 110 of the coating device 100. Stated another way, a magnetic field is created by a magnet placed on an exterior surface of the hollow vessel. Such external manipulation and/or control of the coating device 100 allows for normal operation of various processes within the hollow vessel to continue while the coating device 100 is in use.

The body 110 of the coating device 100 is hollow to define an internal chamber 140. The internal chamber 140 stores a flowable material, such as a coating material, in the internal chamber 140. The flowable material can be any substance capable of flowing through a channel, such as a fluid, for example. An aperture 118 is defined on the body 110 of the coating device 100 to allow for the flowable material to be injected, or otherwise loaded, into the internal chamber 140 of the coating device 100. The aperture 118 allows for the flowable material to be replaced, or otherwise refilled, for reuse of the coating device 100. In instances, the aperture 118 is self-sealing such that when the flowable material is not being injected, or otherwise loaded, into the internal chamber 140, the aperture 118 is sealed, or otherwise closed. Stated another way, the aperture 118 is biased open when a needle, or other injection member, is inserted therethrough to introduce the flowable material into the internal chamber 140. Upon removal of the needle, or other injection member, from the aperture 118, the aperture 118 closes, or otherwise seals, without any manual intervention. The aperture 118 is closed to prevent unwanted leakage of the flowable material out of the internal chamber 140, to prevent unwanted introduction of contents into the internal chamber, or both. Other approaches to refilling the internal chamber may also be used. For example, in instances, the internal chamber 140 of the coating device 100 may be refilled while positioned within a vessel, such as the hollow vessel 1000. In such instances, a refill object can be inserted into the hollow vessel 1000 carrying replacement, or otherwise additional, flowable material. Such refill object can include a needle, or other suitable injection device, that can be inserted into the aperture 118 to refill the internal chamber 140 of the coating device 100.

In instances, a bladder 130 storing a pressurizing gas is positioned within the internal chamber 140 to pressurize the coating device 100. The bladder 130 is at least partially surrounded by the flowable material within the internal chamber 140. The bladder 130 can be made out of butyl rubber, hydrogenated nitrile butadiene rubber (HNBR), and/or any other suitable material that can expand, be compressed, and withstand conditions that are higher than system pressure and temperature. An aperture 138 is defined in the bladder 130 to permit the pressurized gas to be injected, or otherwise loaded, into the bladder 130. The pressure within the bladder 130 is higher than the pressure within the hollow vessel to enable the coating material to be released from the coating device 100. In instances, the internal chamber and the bladder are both generally spherical. In such instances, the coating material resides in a generally spherical shell space between the bladder 130 and the interior surface 114 of the body 110. Other shapes for the internal chamber and bladder may be used.

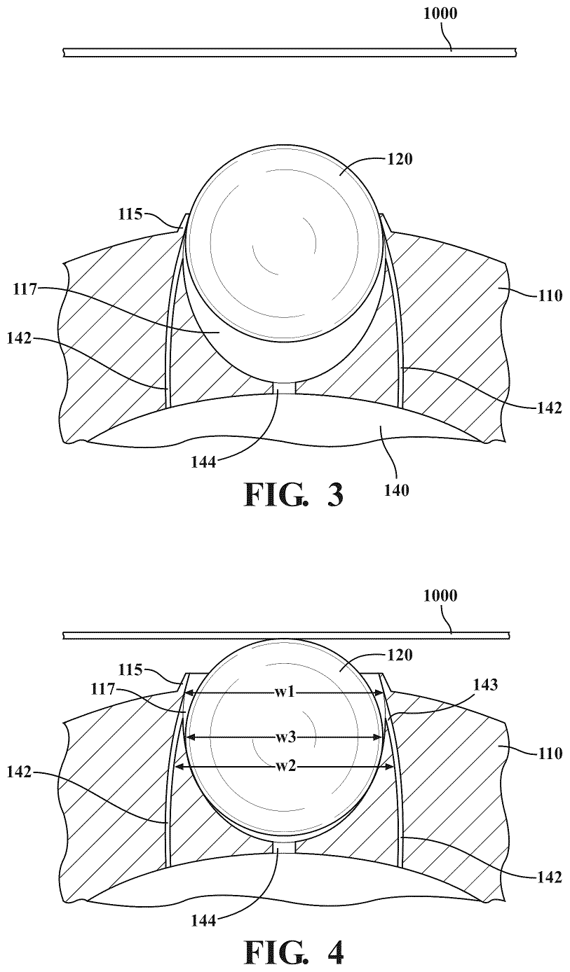

One or more cavities 117 are defined in the body 110 of the coating device 100 to support a coating delivery member 120 therein. Detailed views of one of the one or more cavities 117 are shown in FIGS. 3 and 4. As shown in FIGS. 1-4, the coating delivery member 120 can include a ball, or sphere. Each of the one or more cavities 117 is defined by a first width w1 and a second width w2. The first width w1 is taken at a position closer to the exterior surface 112 of the body 110 than the second width w2. The first width w1 is less than the second width w2 such that the cavity width tapers as the cavity 117 reaches the exterior surface 112. A lip 115 may extend from the exterior surface 112 of the body 110 to surround at least a portion of each cavity 117. A presence of the lip 115 may service to direct a flow of content out of the cavity 117 to a targeted, or otherwise desired area. Stated another way, the lip 115 may serve to form an isolated region to which content flows out of the cavity 117.

One or more channels 142 are defined in the body 110 of the coating device 100 to facilitate the flow of the coating material out of the internal chamber 140. The one or more channels 142 connect the internal chamber 140 to the cavity 117. A flow path of the coating material is defined from the internal chamber 140, through the one or more channels 142, and out of the cavity 117. Once the coating material flows out of the cavity 117, the coating material is brought into contact with an adjacent article, such as the wall of the hollow vessel, for example. In instances, the one or more channels 142 are defined around a perimeter of the cavity 117. In instances, an annular channel 142 is defined continuously around the perimeter of the cavity 117. In instances, the one or more channels 142 are defined equidistantly from one another throughout the cavity 117. Alternatively or additionally, the one or more channels 142 can be defined in the center of the cavity 117.

In instances, the exterior surface 112 further includes one or more bristles extending therefrom. The one or more bristles can serve as a brushing mechanism to ensure a smooth coating of coating material within the hollow vessel 1000 as the coating material is dispensed from the coating device 100.

As described above, a coating delivery member 120 is supported within each of the one or more cavities 117. As depicted in FIGS. 1-4, the coating delivery member 120 is spherical; however, any suitable geometry of the coating delivery member 120 is envisioned. The coating delivery member 120 is defined by a maximum width w3 that is greater than the first width w1 of the cavity 117 such that the coating delivery member 120 is prevented from falling out of, or otherwise detaching from, the cavity 117, for example. The coating delivery member 120 is movable between a first position and a second position within the cavity 117. In the first position, as shown in FIG. 3, a portion of the coating delivery member 120 extends above the exterior surface 112 and the lip 115 of the body 110. As such, when the coating device 100 makes contact with an adjacent article, such as the wall of the hollow vessel 1000, the coating delivery member 120 is the first component of the coating device 100 to make contact. Notably, when the coating delivery member 120 is in the first position, the coating delivery member 120 blocks the flow path of the coating material between the one or more channels 142 and the cavity 117, thereby preventing the coating material from flowing out of the coating device 100.

The coating delivery member 120 can be maintained in the first position by the pressure exerted from the inside of the coating device 100. More specifically, the bladder 130 exerts a pressure on the coating material surrounding the bladder 130 in the internal chamber 140. In turn, the coating material pushes outwardly against the coating delivery member 120 to maintain the coating delivery member 120 in the first position in the absence of an external, opposite force.

In instances, a sealant rubber, or any other suitable material that can be compressed and withstand system conditions, can be positioned in the cavity 117 underneath the coating delivery member 120 to prevent the pressurizing gas from escaping the system, for example. In such instances, the sealant rubber can maintain the coating delivery member 120 in the first position. In instances, the bladder 130 is connected to the cavity 117 through a passageway 144. The passageway 144 is not in contact with, or otherwise exposed to, the coating material stored in the internal chamber 140. The connection between the bladder 130 and the cavity 117 allows for a pressure to be exerted on the coating delivery member 120 to maintain the coating delivery member 120 in the first position in the absence of an opposing force. In instances, a gasket is positioned at a base of the coating delivery member 120 to prevent gas from leaking.

In instances, a non-ferromagnetic spring, or any other suitable physical mechanism, can be positioned in the cavity 117 underneath the coating delivery member 120 in place of the sealant rubber, for example. The spring can maintain coating delivery member 120 in the first position unless there an opposing force externally acting upon the coating delivery member 120 that is significant, or otherwise strong, enough to compress the spring to motivate the coating delivery member 120 into the second position. Once the opposing force is discontinued, or is no longer sufficient enough to compress the spring, the spring will return toward its normal form, causing the coating delivery member 120 to move back to the first position.

Upon making contact with an adjacent article, such as the wall of the hollow vessel 1000, the coating delivery member 120 is biased, or otherwise moved, from the first position toward the second position within the cavity 117. As shown in FIG. 4, the coating delivery member 120 is pushed, or otherwise moved, away from the exterior surface 112 and toward the interior surface 114 of the body 110 as the coating delivery member 120 is transitioned into the second position. As the coating delivery member 120 is moved into the second position, the coating delivery member 120 moves away from an end 143 of the one or more channels 142 thereby unblocking the flow path of the coating material. When the coating delivery member 120 is in the second position, the coating material is able to freely flow out of the end 143 of the one or more channels 142, into the cavity 117, and out of the coating device 100. In instances, the inward movement of the coating delivery member 120 into the second position opposes the pressure pushing the coating delivery member 120 out of the cavity 117. Such an inward force presses against the coating material stored within the internal chamber 140 causing the flexible bladder 130 to expand, or otherwise displace, in one or more areas, thereby pushing, or otherwise facilitating, the flow of the coating material from the internal chamber 140 through the one or more channels 142, and out of the cavity 117. However, a primary cause of expanding the bladder 130 is the fact that the bladder 130 is pressurized with gas at a level higher than the system pressure, for example. The pressurized bladder 130 actively pushes the coating material outward as it is trying to expand; however, when the coating delivery member 120 is in the first position, the channel path is closed and the coating material is prevented from leaving the system. Once the coating delivery member 120 is in the second position, the channel path is open and the coating material can freely leave the system. Thus, the bladder 130 is able to expand and in the process, will push the coating material through the opened channels.

In order to begin transitioning into the second position, the coating delivery member 120 must make contact with the adjacent article to a degree that overcomes the pressurizing force holding the coating delivery member 120 in the first position. Such a requirement prevents inadvertent flow of coating material when the coating device 100 makes contact with any adjacent article. As described herein, the externally-created magnetic field ensures that the coating delivery member 120 is brought into sufficient contact with the wall of the hollow vessel when the coating device 100 is in the desired location.

As sufficient contact is needed in order to transition the coating delivery member 120 into the second position, it is possible for the coating device 100 to have one or more coating delivery members 120 transitioning into the second position while one or more coating delivery members 120 remain in the first position. For example, a first coating delivery member 120 can be located on a first side of the coating device 100 that is in contact with the wall of the hollow vessel 1000 and a second coating delivery member 120 can be located on a second side of the coating device 100 that is not in contact with any adjacent article. In such instances, the first coating delivery member 120 is activated to disperse coating material while the coating material is prevented from flowing out of the second coating delivery member 120.

In instances, the coating delivery member 120 is rotationally fixed in placed when supported within the cavity 117. Alternatively, the coating delivery member 120 is rotatable within the cavity 117.

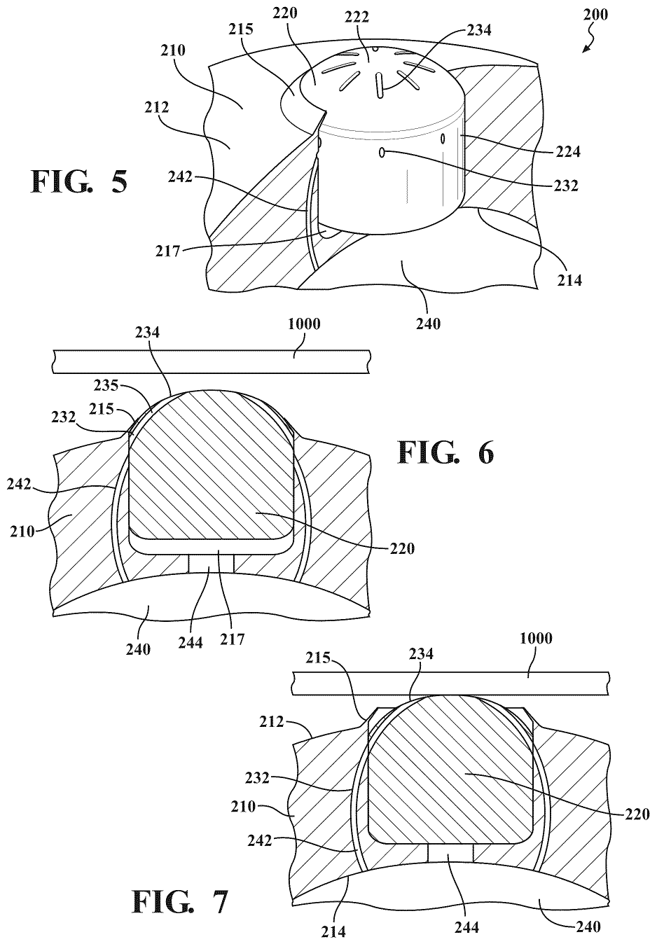

FIGS. 5-7 depict an alternate embodiment of a portion of a generally spherical coating device 200 movable through a hollow vessel to selectively apply a flowable material, such as a coating material, to a wall of the hollow vessel. The coating device 200 is similar in many respects to the coating device 100. Thus, for the purposes of brevity, the particular details of similar features will not be repeated herein.

The coating device 200 includes a body 210 that is generally spherical to allow the coating device 200 to roll, or otherwise move, along the wall of the hollow vessel. The body 210 of the coating device 200 includes an exterior surface 212 and an interior surface 214. At least a portion of the body 210 is made of a ferromagnetic material to allow for the coating device 200 to be selectively moved through the hollow vessel by an external magnetic field, for example. Additionally or alternatively, one or more ferromagnetic members can be coupled to the body 210 of the coating device 200.

Similar to the body 110 of the coating device 100, the body 210 of the coating device 200 is hollow to define an internal chamber 240. The internal chamber 240 stores a flowable material, such as a coating material, in the internal chamber 240. One or more channels 242 are defined in the body 210 of the coating device 200 to facilitate the flow of the coating material from the internal chamber 240.

FIGS. 5-7 depict a single cavity 217 from one or more cavities 217 defined in the body 210 of the coating device 200 to support a coating delivery member 220 therein. A lip 215 may extend from the exterior surface 212 of the body 210 to surround at least a portion of each cavity 217. As depicted in FIGS. 5-7, the coating delivery member 220 is a spray nozzle. An exterior surface 222 of the coating delivery member 220 is rounded; however, any suitable geometry of the coating delivery member 220 is envisioned. The coating delivery member 220 includes one or more channels 235 defined therethrough to receive the coating material from the one or more channels 242 defined in the body 210 of the coating device 200. More specifically, a first end 232 of a channel 235 is defined in a sidewall 224 of the coating delivery member 220. The first end 232 of the channel is aligned with the channel 242 defined in the body 210 of the coating device 200, such that the flow path of the coating material extends from the internal chamber 240 through the channel 242 defined in the body 210 of the coating device 200, and through the first end 232 of the channel 235 defined in the coating delivery member 220. A second end 234 of the channel 235 is defined in an exterior surface 222 of the coating delivery member 220.

Similar to the coating delivery member 120, the coating delivery member 220 is movable between a first position and a second position within the cavity 217. In the first position, as shown in FIG. 6, a portion of the coating delivery member 220 extends above the exterior surface 212 and the lip 215 of the body 210. As such, when the coating device 200 makes contact with an adjacent article, such as the wall of the hollow vessel 1000, the coating delivery member 220 is the first component of the coating device 200 to make contact. Notably, when the coating delivery member 220 is in the first position, the first end 232 of the channel 235 defined in the coating delivery member 220 is not aligned with the channel 242 defined in the body 210 of the coating device 200. As such, when the coating delivery member 220 is in the first position, the flow path of the coating material is disconnected, or otherwise blocked, thereby preventing the coating material from flowing out of the coating device 200.

The coating delivery member 220 can be maintained in the first position by the pressure from the inside of the coating device 200. In instances, a sealant rubber, or any other suitable material that can be compressed and withstand system conditions, can be positioned in the cavity 217 underneath the coating delivery member 220 to prevent the pressurizing gas from escaping the system, for example. In instances, a gasket is positioned at a base of the coating delivery member 220 to prevent gas from leaking out of the system. In instances, the bladder 130 is connected to the cavity 217 through a passageway 244. The passageway 244 is not in contact with, or otherwise exposed to, the coating material stored in the internal chamber 240. The connection between the bladder 130 and the cavity 217 allows for a pressure to be exerted on the coating delivery member 220 to maintain the coating delivery member 220 in the first position in the absence of an opposing force.

Upon making contact with an adjacent article, such as the wall of the hollow vessel 1000, the coating delivery member 220 is pushed, or is otherwise displaced, from the first position toward the second position. As shown in FIG. 7, the coating delivery member 220 moves away from the exterior surface 212 and toward the interior surface 214 of the body 210 as the coating delivery member 220 is transitioned into the second position. As the coating delivery member 220 is moved into the second position, the first end 232 of the channel 235 becomes aligned with the channel 242 defined in the body 210 of the coating device 200, thereby connecting the flow path of the coating material from the body 210 of the coating device 200 to the exterior environment.

With the coating delivery member 220 in the second position, the coating material travels out of the interior chamber 240 through the one or more channels 242 defined in the body 210 of the coating device 200, through the first end 232 of the channel 235 defined in the coating delivery member 220, and out of the second end 234 of the channel 235 to a desired location on the hollow vessel 1000. Movement of the coating delivery member 220 into the second position can result in coating material being sprayed, or otherwise dispensed, out of the second end 234 of the channel 235.

In order to begin transitioning into the second position, the coating delivery member 220 must make contact with the adjacent article to a degree that overcomes the pressurizing force holding the coating delivery member 220 in the first position. Such a requirement prevents inadvertent flow of coating material when the coating device 200 makes contact with any adjacent article. As described herein, the externally-created magnetic field ensures that the coating delivery member 220 is brought into sufficient contact with the wall of the hollow vessel when the coating device 200 is in the desired location.

In instances, the exterior surface 212 further includes one or more bristles extending therefrom. The one or more bristles can serve as a brushing mechanism to ensure a smooth coating of coating material within the hollow vessel 1000 as the coating material is dispensed from the coating device 200.

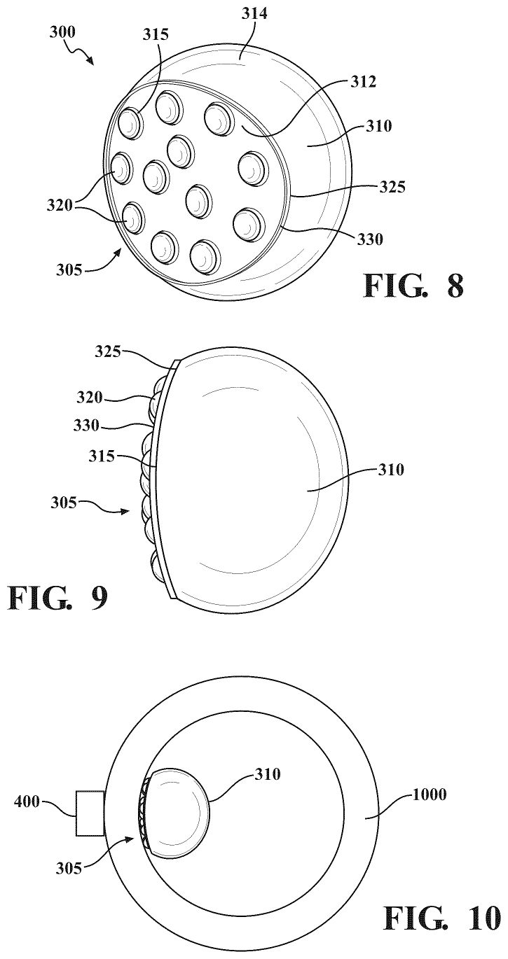

FIGS. 8-10 depict a coating device 300 for coating a desired, isolated location on a wall of a hollow vessel. The components of the coating device 300 are similar in many respects to the coating devices 100, 200. Thus, for the purposes of brevity, the particular details of similar features will not be repeated herein. The coating device 300 includes a body 310 having a hemispherical geometry. A first portion 312 of the body 310 includes an interface 305 that has a corresponding, or otherwise matching, geometry to the geometry of an adjacent surface to be coated, such as the wall of the hollow vessel 1000. In instances, at least a portion of the interface 305 is ferromagnetic so as to be selectively secured against the wall of the hollow vessel 1000 by an external magnet. Additionally or alternatively, one or more ferromagnetic members are coupled to the interface 305.

The first portion 312 of the body 310 is defined by a perimeter 325. In instances, a raised projection 330 extends from the body 310 around the perimeter 325 to further isolate the interface 305 from which a coating material is dispensed. Such a raised projection 330 serves to keep the dispensed coating material in an isolated, targeted location on the hollow vessel 1000 allowing the coating device 300 to deliver the coating material to a more precise location, for example.

In instances, the body 310 further includes one or more bristles extending therefrom. The one or more bristles can serve as a brushing mechanism to ensure a smooth coating of coating material within the hollow vessel 1000 as the coating material is dispensed from the coating device 300. In instances, the one or more bristles can be positioned within the first portion 312 of the body 310. In other instances, the one or more bristles can be positioned around the body 310.

Similar to the coating devices 100, 200, one or more cavities are defined in the body 310 of the coating device 300 to support a coating delivery member 320 therein. A lip 315 may extend from the exterior surface of the body 310 to surround at least a portion of each cavity. The coating delivery members 320 are illustrated in a generic manner, as the coating delivery members 120, the coating delivery members 220, or a combination thereof are suitable for use with the coating device 300. In instances where the raised projection is present around the perimeter 325, the coating delivery members 320 remain the first point of contact with the adjacent article to ensure a sufficient force is exerted thereon to dispense the coating material.

As described herein, an external magnetic field is created to manipulate, move, or otherwise control the placement of the various coating devices. The external magnetic field can be created by placing an electromagnet 400 on an exterior surface of the hollow vessel 1000. The electromagnet is selectively enabled and disabled by supplying and reducing an electrical current, respectively. The external magnetic field can also be created by placing a permanent magnet 400 on the exterior surface of the hollow vessel 1000; however, the permanent magnet may lose its magnetism strength if used with systems that involve high temperatures. A required pulling strength of the magnet 400 is case-dependent and is based on various characteristics including, for example, a diameter of the hollow vessel, the velocity of content flowing within the hollow vessel, a viscosity of the content flowing within the hollow vessel, and/or a specific permeability of the ferromagnetic material used to manufacture at least a portion of the coating devices.

Various features of the described coating devices can be modified to achieve a particular coating feature such as the speed of which the coating material is dispensed and the coverage of the coating material being dispensed, for example. Should it be desirable to distribute a greater amount of coating material, a diameter of the channel, such as channel 142, can be increased. Additionally or alternatively, a greater number of channels can be defined in the body of the coating device. Should it be desirable to distribute the coating material at an increased velocity, the diameter of the channel, such as channel 142, can be decreased, for example. Stated another way, the number and/or size of coating delivery members can be increased or decreased accordingly.

While various systems and methods have been described for orienting, or otherwise moving, a coating device within a vessel, the coating device and the components thereof may be introduced to the vessel by way of an injection system, for example. Exemplary injection systems are described in greater detail in commonly-owned and co-pending U.S. patent application Ser. No. 18/344,498, entitled SYSTEMS AND PROCESSES FOR CHEMICAL PROCESSING, filed on Jun. 29, 2023, the entirety of which is hereby incorporated by reference. Such injection systems can be for injecting elements into an internal volume of a vessel through at least one inlet.

One or more coating devices 100, 200, 300 can be simultaneously operating in the hollow vessel at any given time. Moreover, use of the one or more coating devices 100, 200, 300 is not limited to when normal operations within the hollow vessel are online, or otherwise functioning. Such coating devices 100, 200, 300 are also intended for use when the hollow vessel is offline, or otherwise shutdown. In instances where the coating devices 100, 200, 300 are operational in an offline hollow vessel, a hose can be coupled to the aperture, such as aperture 118, of the coating device to continuously provide a supply of coating material to the internal chamber.

The described coating devices provide various benefits over conventional solutions. For example, the described coating devices are able to selectively apply a coating layer without adversely affecting normal operation of the vessel. Stated another way, use of the described coating devices eliminates the need for a process shutdown or unit isolation for coating application, as the described coating devices eliminate a need to cool down the process equipment, heater tubes, and/or process lines as well as eliminate a need for a pressure letdown, for example.

The coating devices disclosed herein can be used to perform a method for applying a coating layer to an interior wall of a hollow vessel. The method includes introducing a coating device into the hollow vessel, the coating device having a body defining an internal chamber, a flowable coating material stored in the internal chamber, a cavity defined in the body, a coating delivery member supported in the cavity, the coating delivery member movable between a first position and a second position, and a channel defined in the body, wherein the channel extends between the cavity and the internal chamber. The method further includes positioning a magnet on an external wall of the hollow vessel at a first location, activating the magnet to attract the coating device to the first location, displacing the coating delivery member into the second position by bringing the coating delivery member into contact with the internal wall of the hollow vessel, and deactivating the magnet to release the coating device from the first location, wherein the coating delivery member is biased into the first position by the pressurized coating material when the coating delivery member is no longer in contact with the internal wall of the hollow vessel. In instances, the method includes positioning the magnet on the external wall of the hollow vessel at a second location, activating the magnet to attract the coating device to the second location, displacing the coating delivery member into the second position by bringing the coating delivery member into contact with the internal wall of the hollow vessel, and deactivating the magnet to release the coating device from the second location, wherein the coating delivery member is biased into the first position when the coating delivery member is no longer in contact with the internal wall of the hollow vessel.

In instances, the method can alternatively or additionally include positioning one or more magnets at an injection point to attract the coating device at a beginning, or first location, of the hollow vessel. The one or more magnets can then be moved along a length of the hollow vessel, attracting the coating device along the way, thereby coating an entirety of the hollow vessel. In instances where the coating device needs refilled with coating material, the one or more magnets can attract the coating device to an extraction point where the one or more magnets can be disabled and the coating device can be removed therethrough. The coating device can then be refilled and/or a second coating device can be inserted through the extraction point and the one or more magnets can be activated to continue the coating procedure therefrom.

It may be noted that one or more of the following claims utilize the terms “where,” “wherein,” or “in which” as transitional phrases. For the purposes of defining the present technology, it may be noted that these terms are introduced in the claims as an open-ended transitional phrase that are used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure.

Having described the subject matter of the present disclosure in detail and by reference to specific embodiments, it may be noted that the various details described in this disclosure should not be taken to imply that these details relate to elements that are essential components of the various embodiments described in this disclosure, even in cases where a particular element may be illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

1. A coating device for coating an internal wall of a hollow vessel, the coating device comprising:
a body defining an internal chamber;
a flowable coating material stored in the internal chamber;
a cavity defined in the body;
a coating delivery member supported in the cavity, the coating delivery member movable between a first position and a second position; and
a channel defined in the body, wherein the channel extends between the cavity and the internal chamber, wherein the coating material flows out of the internal chamber through the channel, wherein the coating delivery member prevents the coating material from flowing out of the channel when the coating delivery member is in the first position, and wherein the coating delivery member facilitates the coating material to flow out of the channel when the coating delivery member is in the second position.

2. The coating device of claim 1, further comprising a pressurized bladder positioned within the internal chamber, wherein the flowable coating material surrounds at least a portion of the pressurized bladder, wherein the pressurized bladder maintains the coating delivery member in the first position when the coating device is positioned apart from the internal wall of the hollow vessel.

3. The coating device of claim 1, wherein the coating delivery member is displaced into the second position when the coating device is in contact with the internal wall of the hollow vessel.

4. The coating device of claim 1, wherein the body comprises a ferromagnetic material.

5. The coating device of claim 1, wherein the coating device is selectively moved through the hollow vessel by an externally placed magnet.

6. The coating device of claim 1, wherein the coating delivery member comprises a ball.

7. The coating device of claim 6, wherein the ball is rotatably supported within the cavity.

8. The coating device of claim 1, wherein the body further comprises a self-sealing aperture for injecting coating material therethrough.

9. The coating device of claim 2, wherein the body further comprises an aperture to permit a pressurized gas to be loaded into the bladder.

10. The coating device of claim 1, wherein the body further comprises an interface having a geometry that is complementary to a geometry of the internal wall of the hollow vessel.

11. The coating device of claim 1, wherein the coating material freely flows out of the cavity when the coating delivery member is in the second position, wherein a flow path of the coating material is defined as passing out of the internal chamber, through the channel, and out of the cavity when the coating delivery member is in the second position.

12. The coating device of claim 1, wherein the coating delivery member comprises a spray nozzle.

13. The coating device of claim 2, wherein the pressurized bladder is flexible and is generally spherical.

14. The coating device of claim 1, wherein the body comprises an exterior surface, wherein a lip extends from the exterior surface of the body to surround at least a portion of the cavity.

15. The coating device of claim 1, wherein the body is hemispherical.

16. The coating device of claim 15, wherein the body comprises a first portion having a perimeter, wherein the cavity is defined within the perimeter, and wherein a raised projection extends from the body around the perimeter.

17. The coating device of claim 1, wherein the body is generally spherical.

18. The coating device of claim 1, wherein the cavity comprises a plurality of cavities defined in the body, and wherein the plurality of cavities are equally spaced apart from one another.

19. The coating device of claim 1, wherein the cavity comprises a plurality of cavities defined in the body within a perimeter.

20. A coating system, comprising:
a coating device, comprising:
a body defining an internal chamber;
a flowable coating material stored in the internal chamber;
a cavity defined in the body;
a coating delivery member supported in the cavity, the coating delivery member movable between a first position and a second position; and
a channel defined in the body, wherein the channel extends between the cavity and the internal chamber, wherein the coating material flows out of the internal chamber through the channel, wherein the coating delivery member prevents the coating material from flowing out of the channel when the coating delivery member is in the first position, and wherein the coating delivery member facilitates the coating material to flow out of the channel when the coating delivery member is in the second position;
a hollow vessel, comprising:
an internal wall; and
an external wall; and
a magnet selectively positioned on the external wall of the hollow vessel, wherein the coating device is selectively positioned against the internal wall of the hollow vessel by the magnet.

21. A method for delivering a coating material to an interior wall of a hollow vessel, the method comprising:
introducing a coating device into the hollow vessel, the coating device comprising:
a body defining an internal chamber;
a flowable coating material stored in the internal chamber;
a cavity defined in the body;
a coating delivery member supported in the cavity, the coating delivery member movable between a first position and a second position; and
a channel defined in the body, wherein the channel extends between the cavity and the internal chamber;
positioning a magnet on an external wall of the hollow vessel at a first location;
activating the magnet to attract the coating device to the first location;
displacing the coating delivery member into the second position by bringing the coating delivery member into contact with the internal wall of the hollow vessel; and
deactivating the magnet to release the coating device from the first location, wherein the coating delivery member is biased into the first position when the coating delivery member is no longer in contact with the internal wall of the hollow vessel.

22. The method of claim 21, further comprising:
positioning the magnet on the external wall of the hollow vessel at a second location;
activating the magnet to attract the coating device to the second location;
displacing the coating delivery member into the second position by bringing the coating delivery member into contact with the internal wall of the hollow vessel; and
deactivating the magnet to release the coating device from the second location, wherein the coating delivery member is biased into the first position when the coating delivery member is no longer in contact with the internal wall of the hollow vessel.
